(19) United States
(12) Patent Application Publication
(10) Pub. No.: US 2004/0005161 A1
(43) Pub. Date: Jan. 8, 2004

(54) Non-contact developing type image forming apparatus and color image developing method using the same

(75) Inventor: Myung-Ho Kyung, Suwon-City (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-City (KR)

(21) Appl. No.: 10/609,422

(22) Filed: Jul. 1, 2003

(30) Foreign Application Priority Data
Jul. 2, 2002 (KR) 2002-38051

(51) Int. Cl. G03G 15/06

(52) U.S. Cl. 399/55

(57) ABSTRACT

A non-contact developing type image forming apparatus has Y, M, C and K developers consecutively disposed to attach color toner consecutively onto a photosensitive medium, each of the developers has a developing roller and a supply roller; a power supply to selectively supply power to each of the developing rollers and the supply rollers; and a controller to control the power supply so that a potential difference is generated between the developing rollers and the supply rollers such that the potential difference is consecutively generated at the Y, M, C and K developers. Shock caused by impact between the developers and the photosensitive medium is not generated since the toner can be consecutively attached to the photosensitive medium without moving the Y, M, C and K developers.

### CROSS-REFERENCE TO RELATED APPLICATIONS

This application claims the benefit of Korean Application No. 2002-38051, filed Jul. 2, 2002, in the Korean Intellectual Property Office, the disclosure of which is incorporated herein by reference.

### BACKGROUND OF THE INVENTION

1. Field of the Invention

The present invention relates to an image forming apparatus, and more particularly, to a non-contact developing type image forming apparatus and a color image developing method using the same.

2. Description of the Related Art

Generally, an image forming apparatus such as a laser printer or a photocopying machine forms a toner image by providing toner to a photosensitive medium having an electrostatic latent image formed thereon. The apparatus then prints a desired image by transferring the toner image to a printing paper.

FIG. 1 illustrates a conventional image forming apparatus. As shown in FIG. 1, the conventional image forming apparatus has a LSU (laser scanning unit) 10 to generate a laser beam, a drum-shaped photosensitive medium 20 formed with an electrostatic latent image on its surface by being scanned by the laser beam, and a charge unit 30 to charge the surface of the photosensitive medium 20 to a predetermined electric potential. The conventional apparatus further includes a developing unit 40 to form the toner image by providing the toner to an electrostatic latent image forming portion of the photosensitive medium 20, a transfer unit 50 to transfer the toner image formed on the photosensitive medium 20 to the printing paper, a fixing unit 60 to fix the transferred toner image on the printing paper P, and a paper feed unit 70 to feed the printing paper.

Here, the developing unit 40 includes four developers 42, 43, 44 and 45 to respectively provide color toner of the colors of yellow, magenta, cyan and black. Each of the four developers 42, 43, 44 and 45 has a toner container 46 to store the color toner, a developing roller 47 to provide the color toner stored in the toner container 46 to the electrostatic latent image forming portion of the photosensitive medium 20, and a gap ring 48 to maintain a gap between the developing roller 47 and the photosensitive medium 20. Moreover, each of the developers 42, 43, 44 and 45 is disposed at a circular turret 41 at a predetermined spacing, and the developers 42, 43, 44 and 45 move towards the photosensitive medium 20 one by one due to the rotation of the turret 41.

The transfer unit 50 includes a transfer belt 51 to transfer the toner image formed on the photosensitive medium 20, a first transfer roller 52 to transfer the toner image of the photosensitive medium 20 to the transfer belt 51 and a second transfer roller 53 to transfer the toner image of the transfer belt 51 to the printing paper.

Hereinbelow, the printing process of the conventional image forming apparatus having the above structure will be described.

First, when the LSU 10 scans the laser beam onto the surface of the photosensitive medium 20 charged to the predetermined electric potential by the charge unit 30, an electrostatic latent image is formed on the surface of the photosensitive medium 20. Then, when the yellow developer 42 contacts the photosensitive medium 20 as the turret 41 of the developing unit 40 rotates, the yellow toner stored in the toner container 46 is attached to the electrostatic latent image forming portion of the photosensitive medium 20 via the developing roller 47. At this time, there is a gap between the surface of the photosensitive medium 20 and the surface of the developing roller 47 as the gap ring 48 connected with the developing roller 47 contacts the surface of the photosensitive medium 20. The yellow toner image formed on the photosensitive medium 20 is transferred to the transfer belt 51 at a first transfer nip formed between the photosensitive medium 20 and the first transfer roller 52.

Next, a new electrostatic latent image is formed on the photosensitive medium 20. Moreover, another toner image is formed when the magenta toner is attached to the electrostatic latent image forming portion as the photosensitive medium 20 contacts the magenta developer 43, which is moved by the rotation of the turret 41. The magenta toner image is transferred to the transfer belt 51 by the first transfer roller 52 and the image overlaps with the yellow toner image on the transfer belt 51.

The above developing process and transfer process is repeated with respect to the cyan and the black developers 44 and 45, thus a final image is formed on the transfer belt 51 as the toner images of the four colors are overlapped. In addition, the final image is transferred to the printing paper P at a second transfer nip formed between the transfer belt 51 and the second transfer roller 53. Then, the final image is fixed on the printing paper P by the fixing unit 60.

However, in the above structure, when the four developers 42, 43, 44 and 45 of the developing unit 40 contact the photosensitive medium 20 due to the rotation of the turret 41, noise is generated as the gap ring 48 of the developing unit 40 contacts the surface of the photosensitive medium 20. Moreover, shocks are generated due to the impact between the photosensitive medium 20 and the developing unit 40. These shocks are transferred to the photosensitive medium 20, and the toner image attached to the photosensitive medium 20 is scattered, resulting in diminished print quality.

### SUMMARY OF THE INVENTION

Accordingly, it is an object of the present invention to overcome the above-mentioned problems of the conventional apparatus.

It is another object of the present invention to provide a non-contact developing type image forming apparatus which maintains a gap between a photosensitive medium and a developing unit and a color image developing method using the same.

Additional objects and advantages of the invention will be set forth in part in the description which follows and, in part, will be obvious from the description, or may be learned by practice of the invention.

The foregoing and/or other objects of the present invention are achieved by providing an image forming apparatus including a photosensitive medium; a plurality of developers consecutively disposed to attach a plurality of color toners consecutively onto the photosensitive medium, each of the developers including a developing roller, and a supply roller; a power supply to selectively supply a power to each of the developing rollers and the supply rollers of the developers; and a controller to control the power supply to supply the power so that a potential difference is consecutively generated between the developing rollers and the respective supply rollers.

The developers may include a toner container to store the color toner; a developing roller disposed at an opening of the toner container; a supply roller in contact with the developing roller in order to coat the color toner on a surface of the developing roller; a regulation blade to regulate a thickness of a toner layer on the surface of the developing roller; and a gap ring connected with the developing roller to contact the photosensitive medium.

Accordingly, shock is not generated between the developer and the photosensitive medium as the color toner can be consecutively attached while maintaining a gap between the developers and the photosensitive medium.

The foregoing and/or other objects of the present invention are also achieved by providing a color image developing method for an image forming apparatus to form a color image on a photosensitive medium, including attaching the color toner of the first developer on the photosensitive medium, including supplying a power to each of the supply rollers and the developing rollers, the power supplied to the supply roller of the first developer being greater than the power supplied to the developing roller, and the power supplied to the supply rollers of the second through fourth developers being less than or equal to the power supplied to the developing roller of the first developer; attaching the color toner of the second developer on the photosensitive medium, including supplying the power to each of the supply rollers and the developing rollers such that the power supplied to the supply roller of the second developer is greater than the power supplied to the developing roller of the second developer, and the power supplied to the supply rollers of the first, third and fourth developers is less than or equal to the power supplied to the developing roller of the second developer; attaching the color toner of the third developer on the photosensitive medium, including supplying the power to each of the supply rollers and the developing rollers such that the power supplied to the supply roller of the third developer is greater than the power supplied to the developing roller of the third developer, and the power supplied to the supply rollers of the first, second and fourth developers is less than or equal to the power supplied to the developing roller of the third developer; and attaching the color toner of the fourth developer on the photosensitive medium, including supplying the power to each of the supply rollers and the developing rollers such that the power is supplied to the supply roller of the fourth developer is greater than the power supplied to the developing roller of the fourth developer, and the power supplied to the supply rollers of the first, second and third developers is less than or equal to the power supplied to the developing roller of the fourth developer.

### BRIEF DESCRIPTION OF THE DRAWINGS

These and other objects and advantages of the invention will become apparent and more readily appreciated from the following description of the preferred embodiments, taken in conjunction with the accompanying drawings of which:

FIG. 1 is a schematic view of a conventional image forming apparatus;

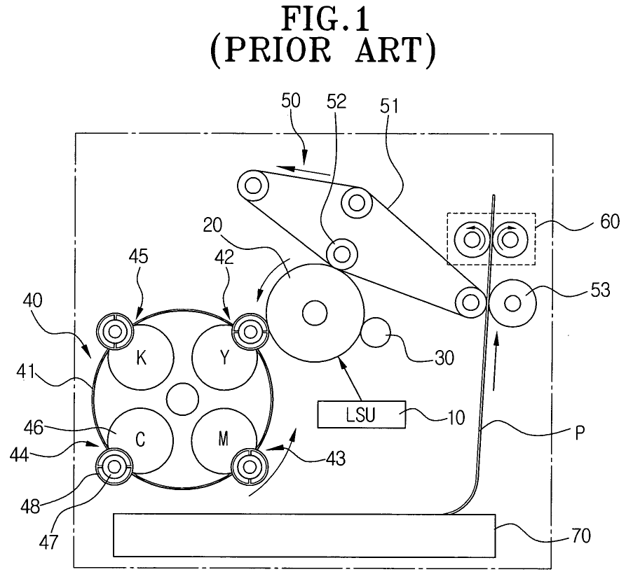

FIG. 2 is a schematic view of a non-contact developing type image forming apparatus according to an embodiment of the present invention; and

FIG. 3 is a schematic view showing portions of FIG. 2.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout.

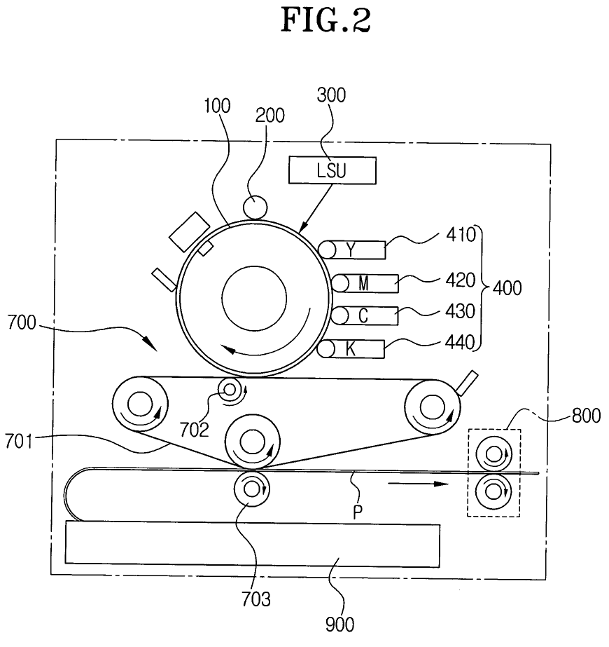

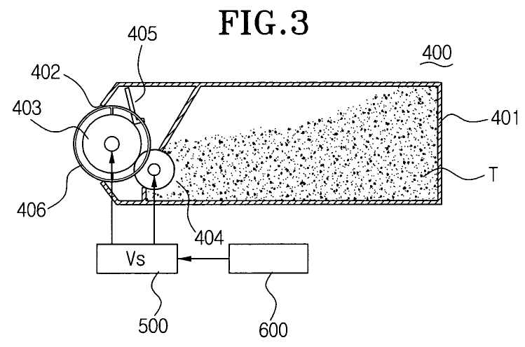

FIG. 2 is a schematic view of a non-contact developing type image forming apparatus according to the present invention and FIG. 3 is a view schematically showing portions of FIG. 2.

As shown in FIGS. 2 and 3, the non-contact developing type image forming apparatus of the present embodiment includes a photosensitive medium 100, a charge unit 200, a laser scanning unit (LSU) 300, a developing unit 400, a power supply 500, a controller 600, a transfer unit 700, a fixing unit 800 and a paper feed unit 900.

The photosensitive medium 100 may be a drum shaped rotation body and an electrostatic latent image is formed on the surface of the medium 100.

The charge unit 200 is installed close to a side of the photosensitive medium 100, and the charge unit 200 charges the surface of the photosensitive medium 100 to a predetermined electric potential.

The LSU 300 forms the electrostatic latent image by scanning a laser beam onto the surface of the photosensitive medium 100.

The developing unit 400 includes four developers such as yellow, magenta, cyan and black 410, 420, 430 and 440 to form a toner image by attaching color toner T of four colors onto an electrostatic latent image forming portion of the photosensitive medium 100.

As shown in FIG. 3, each of the developers 410, 420, 430 and 440 has a toner container 401 to store the color toner T, a developing roller 403 to rotate with respect to an opening 402 of the toner container 401, and a supply roller 404 rotated in contact with the developing roller 403 in order to coat the color toner T onto the surface of the developing roller 403. The developers 410, 420, 430 and 440 further include a regulation blade 405 to regulate a thickness of the toner layer on the surface of the developing roller 403 and a gap ring 406 connected with the developing roller 403 to contact the photosensitive medium 100. The developers 410, 420, 430 and 440 are consecutively disposed without contacting each other so that there is a gap between the surface of the photosensitive medium 100 and that of the developing roller 403. Moreover, the developing roller 403 and the supply roller 404 are supplied with power in order to achieve a predetermined voltage. When there is a potential difference between the rollers 403 and 404, the color toner is coated on the surface of the developing roller 403.

The power supply 500 supplies the power selectively in order to allow the predetermined voltage to the developing roller 403 of the Y, M, C and K developers 410, 420, 430 and 440 and the supply roller 404.

The controller 600 controls the power supply 500 so that the potential difference is generated at the developing rollers 403 of the Y, M, C and K developers 410, 420, 430 and 440 and the supply rollers 404. Here, the potential difference should be consecutively generated at the Y. M, C and K developers 410, 420, 430 and 440.

The transfer unit 700 includes a transfer belt 701 as a transfer medium of the toner image formed on the photosensitive medium 100, a first transfer roller 702 to transfer the toner image of the photosensitive medium 100 to the transfer belt 701 and a second transfer roller 703 to transfer the toner image on the transfer belt 701 to a printing paper.

The paper feed unit 900 feeds the printing paper P to pass through a second transfer nip formed between the transfer belt 701 and the second transfer roller 703.

The fixing unit 800 fixes a transferred final image on the printing paper by applying heat and compression to the printing paper.

Hereinbelow, the printing process of the non-contact developing type image forming apparatus according to the present embodiment will be described.

First, when the laser beam scanned from the LSU 300 reaches the surface of the photosensitive medium 100 charged to the electric potential by the charge unit 200, the electrostatic latent image is formed on the surface of the photosensitive medium 100. In addition, the controller 600 controls the power supply 500 in order to allow greater power to the supply roller 404 of the Y developer 410 than to the developing roller 403 of the Y developer 410. A lower or equal power is applied to the supply rollers 404 of the M, C and K developers 420, 430 and 440 as compared to the developing roller 403 of the Y developer 410. At this time, a sufficient amount of the yellow toner T is coated on the developing roller 403 of the Y developer 410 but is not coated on the developers 420, 430 and 440 (or only a very small amount of the toner is coated on the developing rollers 403 of the developers 420, 430 and 440). Therefore, only the yellow toner T is attached to the electrostatic latent image unit of the photosensitive medium 100 and a yellow toner image is formed. Moreover, the yellow toner image is transferred to the transfer belt 701 at the first transfer nip formed between the photosensitive medium 100 and the first transfer roller 702.

After the transfer with respect to the yellow toner T is completed, a new electrostatic latent image is formed on the photosensitive medium 100 by the laser beam scanned from the LSU 300. In addition, the controller 600 forms a magenta toner image on the surface of the photosensitive medium 100 by controlling the power supply 500 to allow greater power to the supply roller 404 of the M developer 420 than to the developing roller 403 of the M developer. A lower or equal power is applied to the supply rollers 404 of the Y, C, and K developers 410, 430 and 440 as compared to the developing roller 403 of the M developer 420. The magenta toner image is overlapped with the yellow toner image on the transfer belt 701 after being transferred to the transfer belt 701 at the first nip formed between the first transfer roller 702 and the photosensitive medium 100.

The above-described transfer is repeated with respect to the cyan and the black toner T in the same manner. During the process, the controller 600 controls the power supply 500 to allow greater power to the supply roller 404 of the C developer 430 than to the developing roller 403 of the C developer 430. A lower or equal power is applied to the supply rollers 404 of the Y, M, and K developers 410, 420 and 440 as compared to the developing roller 403 of the C developer 430. Next, the controller 600 controls the power supply 500 to allow greater power to the supply roller 404 of the K developer 440 than to the developing roller 403. A lower of equal power is applied to the supply rollers 404 of the Y, M, and C developers 410, 420 and 430 as compared to the developing roller 403 of the K developer 440.

When the first transfer with respect to the toner of four colors is completed, a final image having the overlapped toner images of yellow, magenta, cyan and black is formed on the transfer belt 701. The final image is transferred to the printing paper at the second nip formed between the transfer belt 701 and the second transfer roller 703, and next, the printing process is completed as the final image is fixed to the printing paper by the fixing unit 800.

The order of the developing and the transfer of the toner of the colors can be varied.

According to the present embodiment, the photosensitive medium does not abruptly contact the developer as in the conventional turret rotation method because the Y, M, C and K developers perform non-contact developing with a gap formed with the photosensitive medium. Therefore, the problem of low quality image caused from the toner image being scattered on the photosensitive medium can be solved.

Additionally, the abrasion or breakage of parts caused due to the impact between the developer and the photosensitive medium can be reduced.

Furthermore, as the gap is maintained between the surface of the photosensitive medium and the developing roller due to the gap ring, excess toner on the developers is not attached onto the surface of the photosensitive medium. Therefore, deterioration of the quality of the image can be prevented.

Although a few preferred embodiments of the present invention have been shown and described, it will be appreciated by those skilled in the art that changes may be made in these embodiments without departing from the principles and spirit of the invention, the scope of which is defined in the claims and their equivalents.

What is claimed is:

1. An image forming apparatus comprising:
a photosensitive medium;
a plurality of developers consecutively disposed to attach a plurality of color toners consecutively onto the photosensitive medium, each of the developers comprising:
a developing roller, and a supply roller;
a power supply to selectively supply a power to each of the developing rollers and the supply rollers of the developers; and
a controller to control the power supply to supply the power so that a potential difference is consecutively generated between the developing rollers and the respective supply rollers.

2. The image forming apparatus of claim 1, wherein each of the developers further comprises:
a toner container to store the color toner, the toner container having an opening,
wherein the developing roller is disposed at the opening of the toner container, and the supply roller is disposed in contact with the developing roller in order to coat the color toner on a surface of the developing roller;
a regulation blade to regulate a thickness of a layer of the toner on the surface of the developing roller; and
a gap ring connected with the developing roller to contact the photosensitive medium.

3. A color image developing method for an image forming apparatus to form a color image on a photosensitive medium, comprising:
providing first through fourth developers each comprising:
a supply roller to supply a color toner, and
a developing roller;
attaching the color toner of the first developer on the photosensitive medium, comprising supplying a power to each of the supply rollers and the developing rollers, such that the power supplied to the supply roller of the first developer being greater than the power supplied to the developing roller of the first developer and the power supplied to the supply rollers of the second through fourth developers being less than or equal to the power supplied to the developing roller of the first developer;
attaching the color toner of the second developer on the photosensitive medium, comprising supplying the power to each of the supply rollers and the developing rollers such that the power supplied to the supply roller of the second developer is greater than the power supplied to the developing roller of the second developer, and the power supplied to the supply rollers of the first, third and fourth developers is less than or equal to the power supplied to the developing roller of the second developer;
attaching the color toner of the third developer on the photosensitive medium, comprising supplying the power to the rollers and the developing rollers such that the power supplied to the supply roller of the third developer is greater than the power supplied to the developing roller of the third developer, and the power supplied to the supply rollers of the first, second and fourth developers is less than or equal to the power supplied to the developing roller of the third developer; and
attaching the color toner of the fourth developer on the photosensitive medium, comprising supplying the power to each of the supply rollers and the developing rollers such that the power supplied to the supply roller of the fourth developer is greater than the power supplied to the developing roller of the fourth developer, and the power supplied to the supply rollers of the first, second and third developers is less than or equal to the power supplied to the developing roller of the fourth developer.

4. An apparatus comprising:
a photosensitive medium; and
first and second developing rollers to respectively attach first and second color toners onto the photosensitive medium,
the first and second developing rollers being spaced a constant distance from the photosensitive medium.

5. The apparatus of claim 4, wherein the first and second developing rollers are spaced a same distance from the photosensitive medium.

6. The apparatus of claim 4, further comprising first and second supply rollers to respectively supply the first and second color toners to the first and second developing rollers,
wherein a first power is supplied to the first supply roller, a second power is supplied to the second supply roller, and the first power is greater than the second power.

7. The method of claim 6, wherein a third power is supplied to the first developing roller, the third power being less than the first power, and greater than or equal to the second power.

8. A method to form a color image on a photosensitive medium, comprising:
providing first and second developers each comprising:
a supply roller to supply a color toner to the photosensitive medium, and a developing roller;
supplying a first power to the supply roller of the first developer; and
supplying a second power to the supply roller of the second developer,
the first power being greater than the second power.

9. The method of claim 8, further comprising:
supplying a third power to the developing roller of the first developer,
the third power being less than the first power, and greater than or equal to the second power.
